(19) United States
(12) Patent Application Publication
(10) Pub. No.: US 2014/0134312 A1
(43) Pub. Date: May 15, 2014

(54) METHOD FOR PRODUCING CONDENSED SAFFRON

(71) Applicant: KAYLA INTERNATIONAL LTD., Richmond Hill (CA)

(72) Inventor: Sedigheh GERAMI, Ontario (CA)

(73) Assignee: KAYLA INTERNATIONAL LTD., Richmond Hill (CA)

(21) Appl. No.: 13/675,599

(22) Filed: Nov. 13, 2012

(51) Int. Cl. A23P 1/02

(52) U.S. Cl. CPC A23P 1/022
USPC 426/454; 426/464

(57) ABSTRACT

A method for producing condensed saffron comprises the following steps. First, stigmas of saffron flowers are provided. Next, the stigmas of the saffron flowers are grinded into a powdered saffron. The powdered saffron is then processed through a fine mesh strainer to remove undesirable fibrous plant material. After that, humidity of the powdered saffron is increased to about 8.5-9%, followed by reducing the humidity of the powdered saffron to about 5-6%. Subsequently, the powdered saffron is granulated into saffron grains. The saffron grains are water-soluble and free from any additives and alcohol.

### BACKGROUND OF THE INVENTION

1. Field of the Invention

The present invention relates to methods for producing saffron in general, and, more particularly, to a method for producing condensed saffron tablets.

2. Description of the Prior Art

Saffron is a spice derived from flowers of Crocus sativus, commonly known as the saffron crocus (the saffron flower). Each saffron crocus grows to 20-30 cm (8-12 in) and bears up to four flowers, each with three vivid crimson stigmas at the distal end of a carpel. The carpel also includes styles, or stalks, that connect the stigmas to their host plant. The saffron is made from the dried stigmas of the flower of the saffron plant. The saffron is used in various cuisines mainly as a seasoning and coloring agent, and is also used in medicine. Saffron's bitter taste and iodoform- or hay-like fragrance result from the chemicals picrocrocin and safranal. The saffron also contains a carotenoid dye, crocin, which imparts a rich golden-yellow hue to dishes and textiles. Because each saffron flower's stigmas need to be collected by hand and there are only a few per flower, saffron is one of the most expensive (by weight) spice in the world. The saffron is native to Southwest Asia and was first cultivated in Greece. Iran now accounts for approximately 90 percent of the world production of saffron.

Currently, the powdered saffron, mainly used in cooking, is obtained by process of manually grinding of saffron threads into a fine powder in a mortar and pestle. The powdered saffron then gets dissolved in hot water and then it can be used for cooking However, grinding of the saffron threads in the conventional way has three disadvantages:

1) It is time-consuming: Grinding of the saffron threads is a delicate process and it takes time. It usually takes 3-4 minutes to delicately grind a very small portion of the saffron threads.

2) It wastes saffron: Saffron is a very expensive product. In the process of grinding saffron gets wasted while getting transferred from a saffron threads container to a grinder and from the saffron grinder to cooking pods. Additionally, some residue of the powdered saffron attaches to the walls of the saffron grinders (such as to a wall of a mortar of the mortar and pestle).

3) It results in humidity of saffron: Humidity is the main factor that impacts the quality of taste and color of saffron. The saffron threads should be kept in a very dried environment; otherwise its quality (taste and color) reduces considerably. Keeping saffron in a non-condensed condition helps humidity to get into saffron and ultimately reduces its quality.

While the above-described conventional method of producing the powdered saffron has been commonly used, it is time consuming, wasteful of the saffron threads, and produces the powdered saffron of a poor quality. Therefore, the methods for producing saffron are susceptible to improvements that may enhance their performance and cost. With this in mind, a need exists to develop an improved method of producing condensed saffron that is simple and inexpensive, and produces high quality saffron.

### SUMMARY OF THE INVENTION

The present invention provides a method for producing condensed saffron. The method for producing condensed saffron according to the present invention comprises the following steps. First, stigmas of saffron flowers are provided. Next, the stigmas of the saffron flowers are grinded into a powdered saffron. The powdered saffron is then processed through a fine mesh strainer to remove undesirable fibrous plant material. After that, humidity of the powdered saffron is increased to about 8.5-9%, followed by reducing the humidity of the powdered saffron to about 5-6%. Subsequently, the powdered saffron is granulated into saffron grains. The saffron grains are then compressed into condensed saffron tablets, which are water-soluble and free from any additives and alcohol.

Therefore, the method according to the present invention allows to obtain 100% condensed saffron, which is easy to use, does not waste saffron, and provides 100% saffron with no additives and/or alcohol added. The condensed saffron prepared according to the method of the present invention absorb minimum amount of humidity from the surrounding environment.

### DESCRIPTION OF THE PREFERRED EMBODIMENTS

The exemplary method of the present invention will now be described. The following description of the exemplary embodiment is merely exemplary in nature and is in no way intended to limit the invention, its application, or uses.

For purposes of the following description, certain terminology is used in the following description for convenience only and is not limiting. The words “smaller” and “larger” refer to relative values of characteristic of the elements or ingredients of the method of the present invention and designate portions thereof The terminology includes the words specifically mentioned above, derivatives thereof and words of similar import. Additionally, the word “a”, as used in the claims, means “at least one”.

The present invention relates to a method for producing condensed saffron tablets. The method for producing the condensed saffron tablets comprises the following steps.

First, stigmas of saffron flowers are provided by picking and separating the stigmas from other parts of the saffron flowers in a sanitized environment. The sanitized environment is a term used to describe a sanitary clean environment free from dirt, bacteria, contaminants, etc., where strict sanitized standards for food safety are observed, all instruments are being sterilized and cleaned, and all employees wear gloves and special clothes. In the exemplary embodiment of the present invention, the stigmas of the saffron flowers are handpicked from the saffron flowers.

Further according to the method of present invention, the stigmas of the saffron flowers are grinded into a powdered saffron in a conventional rotary grinder.

Then, the powdered saffron is processed through a fine mesh strainer to remove undesirable fibrous plant material. In the exemplary process of the present invention, the 40 mesh strainer is employed. Those skilled in the art will understand that a mesh is a traditional unit used to measure the fineness of woven products such as fishing nets, fencing fabric, window screening, etc., equal to the number of strands per inch. For n mesh fabric, the distance between strands is 1/n inch or 25.4/n millimeter. In other words, 1 one of the openings between the threads or cords of a net, and is used to designate screen size as the number of openings per linear inch.

Consequently, the powdered saffron is placed in a mixer, such as a helix mixer, and a humidity of the powdered saffron is increased in the mixer to about 8.5-9% by adding distilled water and mixing the powdered saffron with distilled water in the mixer. In the exemplary method of the present invention, about 100 cc of the distilled water is added to 1 kg of the powdered saffron. An electronic hygrometer is used to measure the humidity of the powdered saffron.

Then, the humidity of the powdered saffron is reduced to about 5-6%. Specifically, in the exemplary method of the present invention, the powdered saffron is placed in an oven for about 8 hours at a temperature of approximately 50° C. (or 120° F.) until the humidity of the powdered saffron is reduced to about 5-6%. Again, the electronic hygrometer is used to measure the humidity of the powdered saffron.

After that, the dried powdered saffron is placed in a granulation device, heated again and weighted. During this step, the powdered saffron is granulated into saffron grains.

Subsequently, the saffron grains are compressed into condensed saffron tablets. In the exemplary method of the present invention, the saffron grains are compressed into condensed saffron tablets in a 5-ton single-punch tablet press. The humidity of the condensed saffron tablets is about 5%. It should be understood that the resulted tablets are 100% condensed saffron tablets, which are easily dissolvable in hot water.

The fine mesh strainer in the method of the exemplary embodiment of the present invention is being used for two purposes: 1) helping the saffron tablets get dissolved easier in water or liquids; and 2) in tableting process, using the fine mesh strainer (such as the 40 mesh strainer) assists the powdered saffron to be more tenacious/sticky.

It should be further understood that according to the method of the present invention, no additives and no alcohol is added to the stigmas of the saffron flowers, the powdered saffron and/or the granulated saffron at any step of the above described process.

Therefore, the method according to the present invention allows to obtain 100% condensed saffron tablets in order to reach the following features:

Easy to use: 100% condensed saffron tablets are easy to use. There is no need to grind saffron threads. One just needs to dissolve the 100% condensed saffron tablets into hot water and it gets ready within about a second;

No waste of saffron: The saffron threads will not get wasted in process of grinding and transferring of the saffron threads to the saffron grinder;

Less humidity: the 100% condensed saffron tablets are designed to absorb minimum amount of humidity from the surrounding environment and, therefore, they keep their taste and smell for longer time comparing to the saffron threads;

100% saffron: No additives and/or alcohol have been added to the condensed saffron tablets and they are 100% organic saffron.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A method for producing condensed saffron, said method comprising the steps of:
a) providing stigmas of saffron flowers;
b) grinding said stigmas of said saffron flowers into a powdered saffron;
c) processing said powdered saffron through a fine mesh strainer to remove undesirable fibrous plant material;
d) increasing humidity of said powdered saffron to about 8.5-9%;
e) reducing the humidity of said powdered saffron to about 5-6%; and
f) granulating said powdered saffron into saffron grains.

2. The method for producing condensed saffron as defined in claim 1, wherein the step of providing said stigmas of said saffron flowers comprises the step of handpicking and separating said stigmas of said saffron flowers from other parts of said saffron flowers in a sanitized environment.

3. The method for producing condensed saffron as defined in claim 1, wherein said stigmas of said saffron flowers are grinded into said powdered saffron in a rotary grinder.

4. The method for producing condensed saffron as defined in claim 1, wherein said fine mesh strainer is a 40 mesh strainer.

5. The method for producing condensed saffron as defined in claim 1, wherein the step of increasing humidity of said powdered saffron comprises the step of mixing said powdered saffron with water in a mixer.

6. The method for producing condensed saffron as defined in claim 5, wherein said water is distilled water.

7. The method for producing condensed saffron as defined in claim 6, wherein about 100 cc of said distilled water is added to 1 kg of said powdered saffron.

8. The method for producing condensed saffron as defined in claim 1, wherein the step of reducing said humidity of said powdered saffron to about 5-6% includes the step of heating said powdered saffron in an oven for about 8 hours at about 50° C.

9. The method for producing condensed saffron as defined in claim 1, wherein the step of granulating said powdered saffron into saffron grains includes the steps of placing said powdered saffron in a granulation device and heating said powdered saffron so as to granulate said powdered saffron into said saffron grains.

10. The method for producing condensed saffron as defined in claim 1, wherein said powdered saffron and said saffron grains are free from additives and alcohol.

11. The method for producing condensed saffron as defined in claim 1, further comprising the step compressing said saffron grains into condensed saffron tablets.

12. The method for producing condensed saffron as defined in claim 11, wherein said saffron grains are compressed into said saffron tablets in a press under the pressure of about 5 ton.

13. The method for producing condensed saffron as defined in claim 11, wherein the humidity of said saffron tablets is about 5%.

14. The method for producing condensed saffron as defined in claim 11, wherein said saffron tablets are water-soluble.

15. The method for producing condensed saffron as defined in claim 11, wherein said saffron tablets are free from any additives and alcohol.
